(19) United States
(12) Patent Application Publication
(10) Pub. No.: US 2026/0358038 A1
(43) Pub. Date: Nov. 12, 2026

(54) REFRIGERATOR

(71) Applicant: LG Electronics Inc., Seoul (KR)

(72) Inventors: Jonghwa LEE, Seoul (KR); Taekwon KIM, Seoul (KR); Sihyung KIM, Seoul (KR)

(21) Appl. No.: 19/644,883

(22) Filed: Apr. 10, 2026

(30) Foreign Application Priority Data
May 12, 2025 (KR) 10-2025-0061130

(51) Int. Cl. F25D 23/02; E05D 7/081; F25D 11/02

(52) U.S. Cl. CPC F25D 23/028; E05D 7/081; F25D 11/02; E05Y 2900/31; F25D 2323/022; F25D 2323/024

(57) ABSTRACT

A refrigerator includes a cabinet forming a storage space, a door configured to open and close the storage space, and a hinge rotatably connecting the door to the cabinet. The hinge includes a hinge plate mounted to the cabinet and a pair of hinge pins protruding from the hinge plate and connected to the door. The door has, at left and right sides of the door, a first mounting portion having a first guide groove into which the pair of hinge pins are inserted and a second mounting portion having a second guide groove. The pair of hinge pins are selectively inserted into one of the first mounting portion and the second mounting portion to determine an opening direction of the door.

### CROSS-REFERENCE TO RELATED APPLICATIONS

The present application claims priority under 35 U.S.C. 119 and 35 U.S.C. 365 to Korean Patent Application No. 10-2025-0061130, filed on May 12, 2025, which is hereby incorporated by reference in its entirety.

### BACKGROUND

The present disclosure relates to a refrigerator.

In general, a refrigerator is a household appliance configured to store food at a low temperature in an internal storage space shielded by a door. For this purpose, the refrigerator is configured to cool the interior of the storage space by using cold air generated through heat exchange with a refrigerant circulating in a refrigeration cycle, thereby allowing the stored food to be preserved in an optimal condition.

In recent years, refrigerators have tended to become larger in size and multifunctional in response to changes in dietary habits and a trend toward premium products, and refrigerators having various structures designed in consideration of user convenience have been released.

In particular, recent refrigerators may be installed so as to be embedded in a wall, or arranged to have a layout structure that harmonizes with other furniture or home appliances. In this case, the refrigerator requires a predetermined separation distance in order to prevent interference between a corner portion of a rotating door and an adjacent wall, furniture, or home appliance.

To this end, refrigerators have been developed in which a door of the refrigerator is supported by a plurality of hinge pins, and is opened and closed while a rotational center of the refrigerator door is changed.

However, in such a refrigerator, due to a structure in which a plurality of hinge pins are disposed, structures of hinges at left and right sides are inevitably configured differently from each other. Accordingly, the hinges at the left and right sides must be manufactured and assembled independently, and there is a problem in that misassembly may occur during assembly.

In particular, in a refrigerator door capable of changing a door opening direction, both the left and right hinges must be provided in order to change the door opening direction, and thus there are problems of loss and management.

### SUMMARY

An embodiment of the present invention is directed to providing a refrigerator in which hinges having an identical structure may be selectively mounted at left and right sides of a door.

An embodiment of the present invention is directed to providing a refrigerator in which a single hinge may be selectively used at either one of opposite sides of a door, thereby allowing a door opening direction to be changed.

An embodiment of the present invention is directed to providing a refrigerator in which a hinge plate having a plurality of hinge pins may be selectively mounted at left and right sides of a door.

A refrigerator according to an embodiment of the present invention includes a cabinet forming an upper storage space and a lower storage space arranged vertically; an upper door configured to open and close the upper storage space and having a first lower mounting portion and a second lower mounting portion formed at left and right sides of a lower surface of the lower surface; a lower door configured to open and close the lower storage space an upper surface of the lower door having a first upper mounting portion and a second upper mounting portion formed at left and right sides of the upper surface; and a center hinge mounted to the cabinet, wherein the center hinge comprises: a hinge plate extending between the upper door and the lower door; and a pair of hinge pins passing through the hinge plate and protruding upward and downward, the pair of hinge pins being spaced apart from each other, and wherein, according to an opening direction of the doors, the center hinge is selectively mounted to one of (i) the first lower mounting portion and the first upper mounting portion or (ii) the second lower mounting portion and the second upper mounting portion.

The center hinge is connected to the first lower mounting portion and the first upper mounting portion in a first state such that the upper door and the lower door are opened in a first direction, and the center hinge is connected to the second lower mounting portion and the second upper mounting portion in a second state such that the upper door and the lower door are opened in a second direction, and the second state may be an inverted state of the first state in a vertical direction.

The hinge plate includes a plate fixing portion fixed to a front surface of the cabinet and a plate extension portion extending from the plate fixing portion and having the pair of hinge pins mounted to the plate extension portion, and the plate extension portion may extend forward from a middle point of a vertical height of the plate fixing portion.

At one side of the hinge plate with respect to a center of the hinge plate, fastening holes into which fastening members for fixing the hinge plate are fastened may be formed, and the plate extension portion may be formed at the other side of the hinge plate.

The hinge plate is formed of a metal material, and the plate extension portion may be formed by bending forward from one end of the plate fixing portion.

A plurality of fastening holes may be formed in the plate fixing portion, and the plate extension portion may be formed on an extension line passing through the plurality of fastening holes.

The plate extension portion may be positioned at a middle height of the plate fixing portion.

The first lower mounting portion and the second lower mounting portion may be formed symmetrically with respect to a center of the upper door, and the first upper mounting portion and the second upper mounting portion may be formed symmetrically with respect to a center of the lower door.

Guide grooves into which the pair of hinge pins are inserted and which guide rotation of the doors during opening and closing may be formed in the first lower mounting portion, the second lower mounting portion, the first upper mounting portion, and the second upper mounting portion.

Guide members formed of a wear-resistant material may be mounted in the first lower mounting portion, the second lower mounting portion, the first upper mounting portion, and the second upper mounting portion, and the guide grooves may be formed in the guide members.

The guide grooves formed in the first lower mounting portion and the second lower mounting portion may be formed symmetrically with respect to a center of the upper door, and the guide grooves formed in the first upper mounting portion and the second upper mounting portion may be formed symmetrically with respect to a center of the lower door.

In another aspect, a refrigerator according to an embodiment of the present invention includes a cabinet forming a storage space; a door configured to open and close the storage space; and a hinge mounted to the cabinet and rotatably connected to the door, wherein first and second mounting portions are formed at left and right sides of the door, the first mounting portion being connected to the hinge for opening and closing the door in a first direction, and the second mounting portion being connected to the hinge for opening and closing the door in a second direction, wherein the hinge includes a hinge plate mounted to the cabinet and a pair of hinge pins detachably mounted to the hinge plate, wherein, the pair of hinge pins are mounted to the hinge plate in a first arrangement state and connected to the first mounting portion to open the door in the first direction, and the pair of hinge pins are mounted to the hinge plate in a second arrangement state and connected to the second mounting portion to open the door in the second direction.

An arrangement of the hinge pins in the first arrangement state and an arrangement of the hinge pins in the second arrangement state may be symmetrical with respect to a center of the hinge plate.

Three pin holes may be formed in the hinge plate, and the pair of hinge pins may be mounted to two of the three pin holes.

A plurality of pin holes into which the hinge pins are inserted may be formed in the hinge plate, and the plurality of pin holes may include: a first pin hole formed on an extension line passing through a center of the hinge plate; and a second pin hole and a third pin hole positioned forward of the first pin hole and disposed at left and right sides with respect to the extension line.

The second pin hole and the third pin hole may be spaced apart from the extension line by equal distances and may be spaced apart from the first pin hole by equal distances.

The pair of hinge pins may include a first hinge pin mounted to the first pin hole and a second hinge pin mounted to one of the second pin hole and the third pin hole according to the opening direction of the door.

Threads corresponding to each other may be formed on a lower portion of the hinge pin and in the pin hole such that they are coupled to each other.

The hinge plate may be formed symmetrically with respect to a center of the jimge plate in left and right directions.

Locking portions protruding at left and right sides with respect to the center of the hinge plate may be formed on an outer surface of the hinge plate, and an elastic hook engaged with the locking portion may be formed in the first mounting portion or the second mounting portion.

In still another aspect, a refrigerator according to an embodiment of the present invention includes a cabinet forming a storage space; a door configured to open and close the storage space; and a hinge rotatably connecting the door to the cabinet, wherein the hinge includes a hinge plate mounted to the cabinet and a pair of hinge pins protruding from the hinge plate and connected to the door, wherein first and second mounting portions are formed at left and right sides of the door, the first mounting portion having a first guide groove into which the pair of hinge pins are inserted and the second mounting portion having a second guide groove, and the pair of hinge pins are inserted into one of the first mounting portion and the second mounting portion to determine an opening direction of the door.

The first mounting portion and the second mounting portion may be formed symmetrically with respect to a center of the door.

The first guide groove and the second guide groove may be formed by continuously connecting a plurality of paths extending in different directions, and during opening and closing of the door, the pair of hinge pins may move along different paths among the plurality of paths.

One of the first guide groove and the second guide groove may receive the pair of hinge pins, and a guide cover covering the first guide groove or the second guide groove may be mounted to the other.

The guide cover includes a cover plate mounted to the first mounting portion or the second mounting portion and a cover insertion portion protruding downward from the cover plate and inserted into the first guide groove or the second guide groove, and the guide cover may be formed symmetrically with respect to an extension line passing through a center thereof.

The cover plate may be formed to cover the first mounting portion and the second mounting portion.

The cover insertion portion may be formed symmetrically with respect to the extension line and may include a first circumferential portion extending from the extension line and a second circumferential portion extending from an end of the first circumferential portion to the extension line, and the first circumferential portion and the second circumferential portion may contact an inner surface of the first guide groove or the second guide groove.

Stopper coupling portions to which a stopper limiting an opening angle of the door is mounted may be provided in the first mounting portion and the second mounting portion, and a stopper opening corresponding to the first guide groove and the second guide groove may be formed in the stopper.

The stopper opening may be formed symmetrically in left and right directions and may include a first opening portion corresponding to the first guide groove at one side with respect to an extension line passing through a center of the stopper and a second opening portion corresponding to the second guide groove at the other side with respect to the extension line, and the first opening portion and the second opening portion may be connected to form a single opening.

Hook coupling portions to which an elastic hook restraining the door is mounted may be provided in the first mounting portion and the second mounting portion, and the elastic hook may have a vertically symmetrical shape.

### BRIEF DESCRIPTION OF THE DRAWINGS

FIG. 1 is a front view of a refrigerator according to an embodiment of the present invention.

FIG. 2 is a front view of the refrigerator in which a door of the refrigerator is opened in a first direction.

FIG. 3 is a front view of the refrigerator in which the door of the refrigerator is opened in a second direction.

FIG. 4 is an exploded perspective view illustrating the door separated from the refrigerator.

FIG. 5 is a perspective view of the door.

FIG. 6 is an exploded perspective view illustrating a stopper, a guide member, and an elastic hook of the door separated from each other.

FIG. 7 is a bottom view of the door openable in the first direction.

FIG. 8 is a plan view of the stopper.

FIG. 9 is a plan view of the guide member.

FIG. 10 is a perspective view of a center hinge coupled to the door openable in the first direction.

FIG. 11 is a front view of the center hinge.

FIG. 12 is an exploded perspective view of the center hinge.

FIG. 13 is a bottom view of the door openable in the second direction.

FIG. 14 is a perspective view of the center hinge coupled to the door openable in the second direction.

FIG. 15 is a perspective view illustrating the door openable in the first direction coupled with the center hinge.

FIG. 16 is an exploded perspective view illustrating the door openable in the first direction and the center hinge separated from each other.

FIG. 17 is an exploded perspective view illustrating the door and a guide cover separated from each other.

FIG. 18 is a top view of the door openable in the first direction.

FIG. 19 is a plan view of the guide cover.

FIG. 20 is a perspective view of the guide cover as viewed from below.

FIG. 21 is a perspective view illustrating the door openable in the second direction coupled with the center hinge.

FIG. 22 is a top view of the door openable in the second direction.

FIG. 23 is a perspective view illustrating a lower hinge mounted such that the door is opened in the first direction.

FIG. 24 is a perspective view illustrating the door openable in the first direction coupled with the lower hinge.

FIG. 25 is an exploded perspective view illustrating the door and the lower hinge separated from each other.

FIG. 26 is an exploded perspective view illustrating the stopper, the guide member, the lower hinge, and the elastic hook separated from the door.

FIG. 27 is a perspective view of the lower hinge coupled to the door openable in the first direction.

FIG. 28 is an exploded perspective view of the lower hinge.

FIG. 29 is a perspective view illustrating the lower hinge mounted such that the door is opened in the second direction.

FIG. 30 is a perspective view of the lower hinge coupled to the door openable in the second direction.

### DETAILED DESCRIPTION

Hereinafter, specific embodiments of the present invention will be described in detail with reference to the accompanying drawings. However, the present invention should not be construed as being limited to the embodiments in which the spirit of the present invention is disclosed, and other embodiments falling within the scope of the spirit of the present invention, or other inventions having a retrogressive nature, may be readily proposed through addition, modification, or deletion of other components.

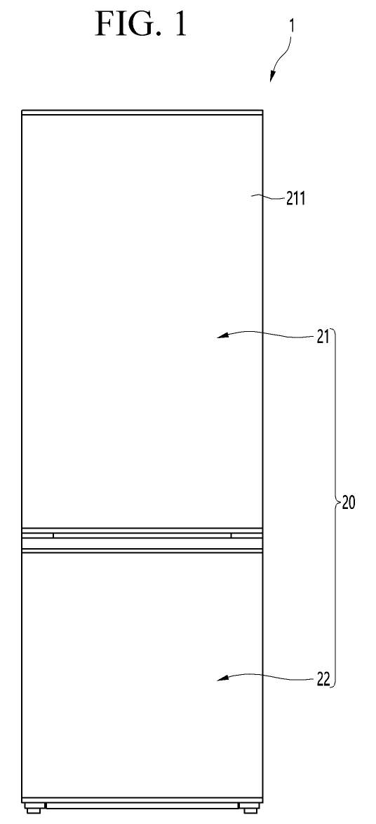

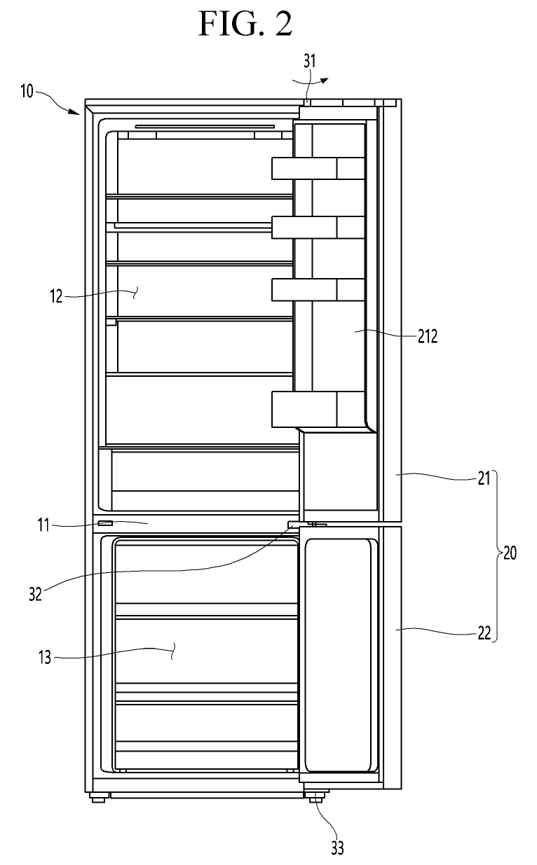

Prior to the description, directions will be defined. In the embodiments of the present invention, as shown in FIGS. 1 and 2, a direction toward a front surface of a door is defined as a front direction, a direction toward a cabinet with respect to the front surface of the door is defined as a rear direction, a direction toward a floor surface on which the refrigerator is installed is defined as a downward direction, and a direction away from the floor surface is defined as an upward direction. Further, when directions that are not defined above are to be described, the directions may be defined and described based on each drawing.

In addition, although the embodiments of the present invention are described by taking, as an example, a refrigerator in which a refrigerating compartment and a freezing compartment are vertically arranged and respective doors are provided, the present invention is not limited to the structure and form of the refrigerator, and it is noted in advance that the present invention is applicable to all types of refrigerators having a rotatable door.

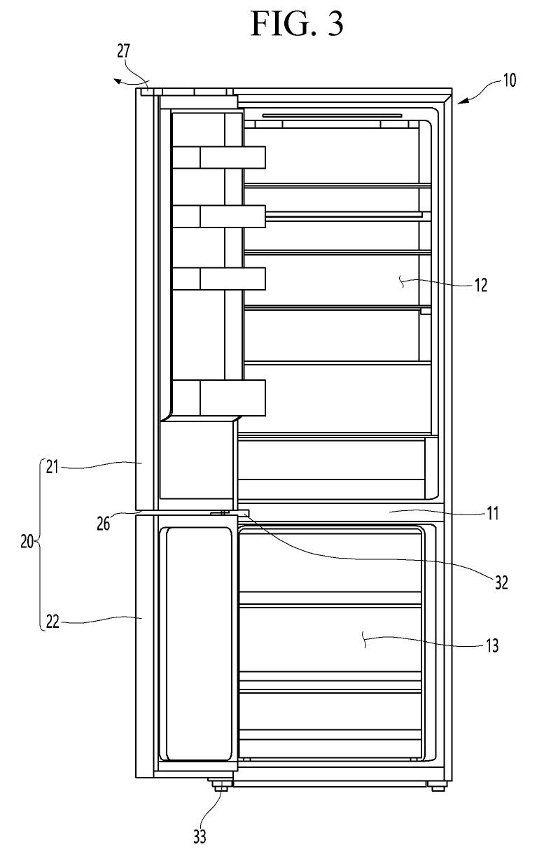

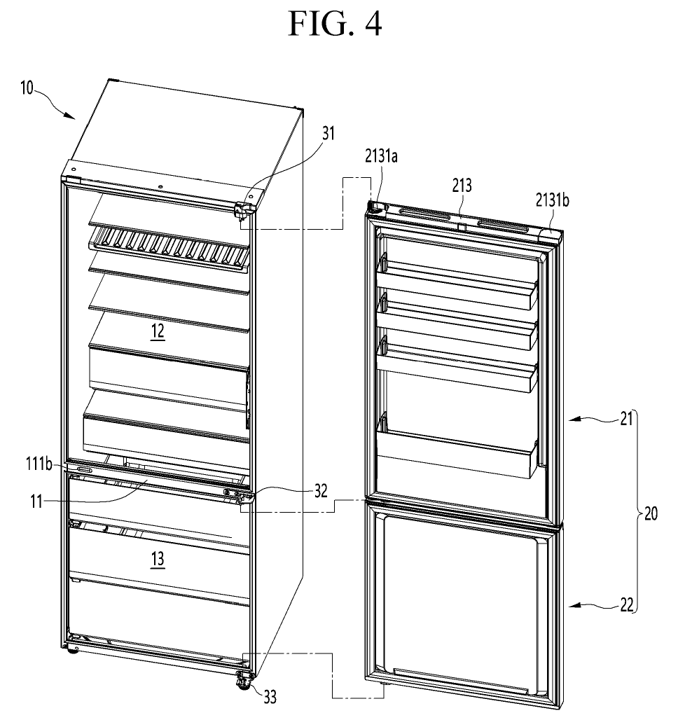

FIG. 1 is a front view of a refrigerator according to an embodiment of the present invention, and FIG. 2 is a front view of the refrigerator in which a door of the refrigerator is opened in a first direction, and FIG. 3 is a front view of the refrigerator in which the door of the refrigerator is opened in a second direction, and FIG. 4 is an exploded perspective view illustrating the door separated from the refrigerator.

As illustrated, a refrigerator 1 according to an embodiment of the present invention may have an overall exterior defined by a cabinet 10 forming a storage space having an open front surface, and a door 20 configured to open and close the storage space.

The refrigerator 1 may be installed so as to harmonize with furniture or a wall in an indoor space. For example, a space corresponding to a size of the refrigerator 1 may be provided in the furniture or the wall to accommodate the refrigerator 1, or the refrigerator 1 may be arranged as a built-in type. Further, a plurality of refrigerators 1 may be installed to be continuously arranged in parallel.

In such an arrangement structure of the refrigerator 1, a front surface of the refrigerator 1, that is, a front surface of the door 20, may be positioned very close to the furniture or the wall, and may be located on the same plane or a proximate plane so as to provide a sense of unity.

In more detail with respect to the structure of the refrigerator 1, the cabinet 10 may have the storage space partitioned in a vertical direction by a barrier 11 to form an upper storage space 12 and a lower storage space 13. For example, the upper storage space 12 may be a refrigerating compartment, and the lower storage space 13 may be a freezing compartment.

The door 20 may be configured to open and close the storage space, and may include an upper door 21 configured to open and close the upper storage space 12 and a lower door 22 configured to open and close the lower storage space 13.

The upper door 21 and the lower door 22 may be rotatably mounted to the cabinet 10 by hinges 31, 32, and 33. The upper storage space 12 and the lower storage space 13 may be opened and closed by rotation of the upper door 21 and the lower door 22.

The hinges may include an upper hinge 31, a center hinge 32, and a lower hinge 33. Depending on a type of the refrigerator, the hinges may include only the upper hinge 31 and the lower hinge 33. Although the present embodiment is described with respect to a refrigerator in which the upper door 21 and the lower door 22 are vertically arranged one above the other, the present invention is not limited thereto and may be applied to any refrigerator having a rotatable door.

For example, the upper hinge 31 and the center hinge 32 may be provided at an upper end and a lower end of the upper door 21, respectively, so as to connect the upper door 21 at upper and lower sides thereof. Further, the center hinge 32 and the lower hinge 33 may be provided at an upper end and a lower end of the lower door 22, respectively, so as to connect the lower door 22 at upper and lower sides thereof. The center hinge 32 may be positioned between the lower end of the upper door 21 and the upper end of the lower door 22, and may be connected to both the upper door 21 and the lower door 22.

Meanwhile, the hinges 31, 32, and 33 may be provided at one of opposite lateral ends of the door 20 so as to allow the door 20 to rotate in one direction. The door 20 may have an opening and closing direction, that is, a rotation direction, changed according to an installation environment of the refrigerator 1 or a user’s preference. To this end, the hinges 31, 32, and 33 may be mounted to the other one of the opposite lateral ends of the door 20. Further, the hinges 31, 32, and 33 may have a structure configured to be selectively mounted at both lateral sides of the door 20. That is, the hinges 31, 32, and 33 having a single structure may be moved and mounted at both lateral sides of the door 20, and thus the opening and closing direction of the door 20 may be changed by moving and mounting the already mounted hinges 31, 32, and 33 without additionally providing separate hinges.

In detail, as illustrated in FIG. 2, when the door 20 is opened in the first direction, the hinges 31, 32, and 33 may be provided at a right side of the cabinet 10 and connected to a right side of the door 20. As illustrated in FIG. 3, when the door 20 is opened in the second direction, the hinges 31, 32, and 33 may be provided at a left side of the cabinet 10 and connected to a left side of the door 20.

The opening and closing direction of the door 20 may be determined according to a mounting position of the hinges 31, 32, and 33. In this case, hinges 31, 32, and 33 having an identical structure may be freely and selectively mounted at left and right sides. That is, the opening and closing direction of the door 20 may be determined by mounting the hinges 31, 32, and 33 having the identical structure at either the left side or the right side.

Hereinafter, structures of the door 20 and the hinges 32 and 33 mounted to the door 20 will be described in more detail with reference to the drawings.

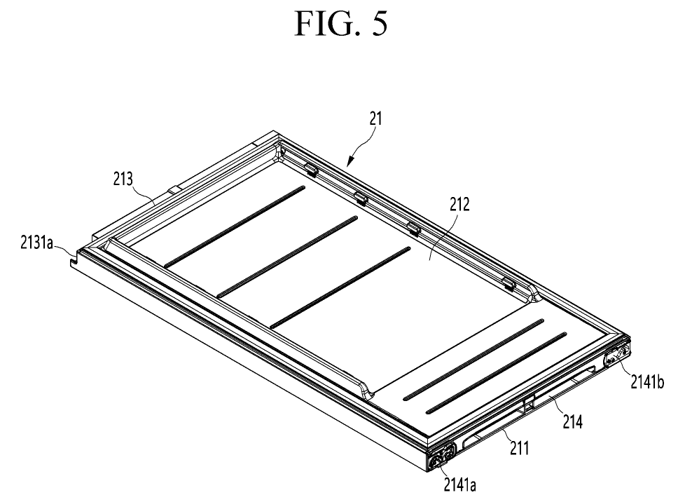

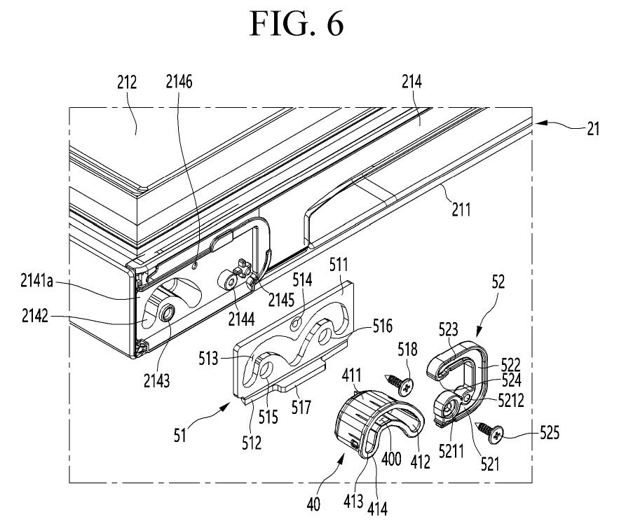

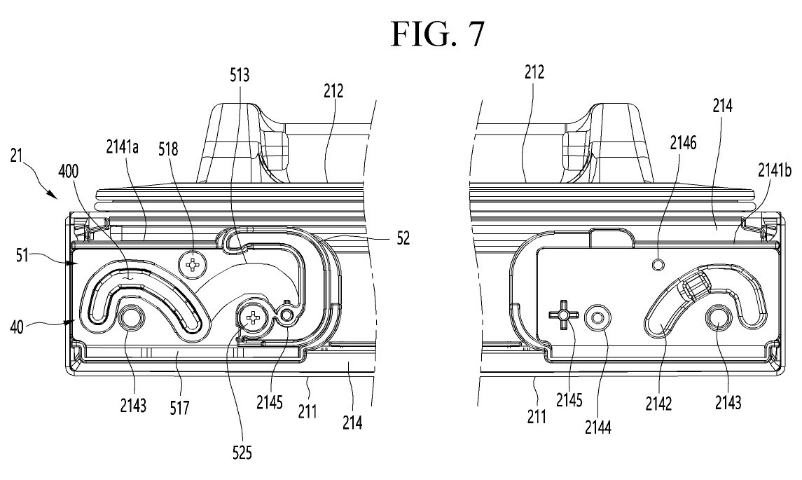

FIG. 5 is a perspective view of the door, and FIG. 6 is an exploded perspective view illustrating a stopper, a guide member, and an elastic hook of the door separated from each other, and FIG. 7 is a bottom view of the door openable in the first direction.

As illustrated, the upper door 21 may include a front panel 211 forming a front surface, a door liner 212 forming a rear surface, an upper cap 213 forming an upper surface, and a lower cap 214 forming a lower surface. In a state in which the front panel 211, the door liner 212, the upper cap 213, and the lower cap 214 are coupled to each other, an insulation material may be filled inside the door 20. Further, the upper door 21 may further include side frames forming left and right side surfaces.

First and second upper mounting portions 2131a and 2131b to which the upper hinge 31 is mounted may be formed at left and right sides of the upper surface of the upper door 21. The first upper mounting portion 2131a and the second upper mounting portion 2131b may be formed on the upper cap 213.

First and second lower mounting portions 2141a and 2141b to which the center hinge 32 is mounted may be formed at left and right sides of the lower surface of the upper door 21. The first lower mounting portion 2141a and the second lower mounting portion 2141b may be formed on the lower cap 214. The first lower mounting portion 2141a and the second lower mounting portion 2141b may be formed to be symmetrical with respect to a center of the upper door 21.

In detail, a guide member mounting groove 2142 into which a guide member 40 is inserted may be recessed in the first lower mounting portion 2141a. The guide member mounting groove 2142 may be formed in a shape corresponding to the guide member 40, and in a state in which the guide member 40 is inserted, a guide groove 400 of the guide member 40 may be exposed downward so that a hinge pin 323 is inserted therein. As necessary, the guide member 40 may be omitted, and the guide member 40 may be integrally formed with the lower cap 214. That is, the guide member mounting groove 2142 may be formed to have the same structure as the guide groove 400, and the hinge pin 323 may be inserted directly into the guide member mounting groove 2142. Accordingly, hereinafter, the guide member mounting groove 2142 may be understood as the guide groove 400.

A stopper coupling portion 2143 and 2144 for coupling a stopper 51 may be formed at the first lower mounting portion 2141a. The stopper coupling portions 2143 and 2144 may be formed as a pair spaced apart from each other at left and right sides, and may protrude so as to pass through coupling holes 515 and 516 of the stopper 51.

A fastening hole 2146 into which a screw 518 for fixing the stopper 51 is fastened may be formed at the first lower mounting portion 2141a. The screw 518 may pass through a through-hole 514 of the stopper 51 and be fastened into the fastening hole 2146 to firmly secure the stopper 51, and the position of the stopper 51 may be maintained by additional fixation through the stopper coupling portions 2143 and 2144. The stopper 51 may have a structure symmetrical with respect to a center thereof and may be configured to be mounted to both the first lower mounting portion 2141a and the second lower mounting portion 2141b.

The stopper 51 may be primarily positioned by insertion of the stopper coupling portions 2143 and 2144 into the coupling holes 515 and 516, and may be firmly mounted to the first lower mounting portion 2141a by fastening of the screw 518. The guide groove 400 may be aligned with a stopper opening 513 when the stopper 51 is mounted. The guide groove 400 formed at the first lower mounting portion 2141a may be referred to as a first guide groove 400 in order to distinguish it from a guide groove 400 formed at the second lower mounting portion 2141b.

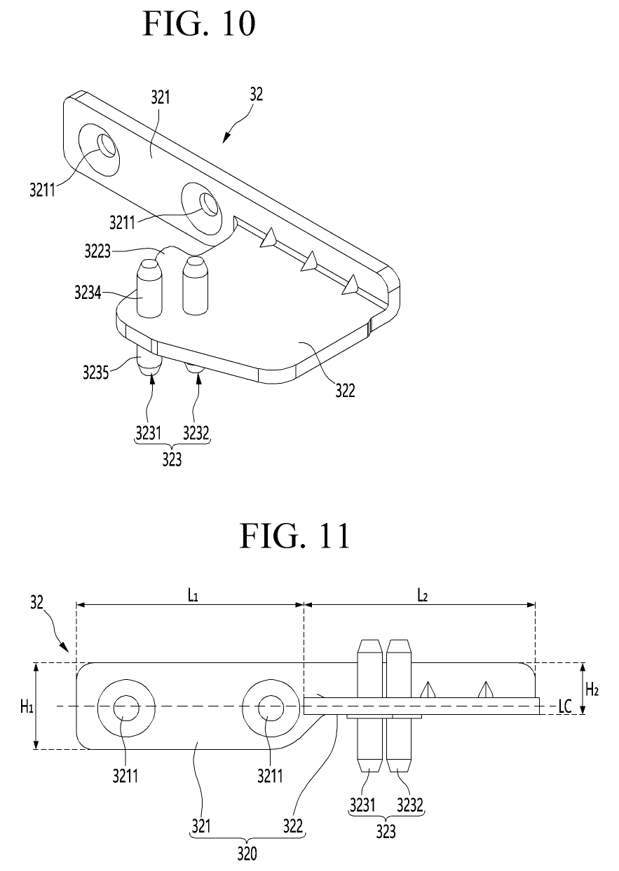

A hook coupling portion 2145 for coupling an elastic hook 52 may be formed to protrude from the first lower mounting portion 2141a. The elastic hook 52 may be restrained by a locking portion 3223 of a hinge plate 320 illustrated in FIG. 10 when the upper door 21 is in a closed state, thereby preventing unintended opening of the upper door 21. The elastic hook 52 may be formed of an elastically deformable material and may be elastically deformed during manipulation for opening the upper door 21, thereby being released from the locking portion 3223 so that the upper door 21 is opened.

The elastic hook 52 may be formed in a continuously bent loop shape, with one end fixed to the lower cap 214 and the other end restrained by the locking portion 3223. For example, the elastic hook 52 may include a hook fixing portion 521 fixed to the first lower mounting portion 2141a, a first hook extension 522 bent from an end of the hook fixing portion 521, and a second hook extension 523 bent from the first hook extension 522 and restrained by the locking portion 3223.

A hook hole 5211 through which a screw 525 for fixing the elastic hook 52 passes may be formed in the hook fixing portion 521. The hook hole 5211 may be positioned to correspond to the stopper coupling portion 2144 at one side. The stopper coupling portion 2144 may be inserted into the hook fixing portion 521. Accordingly, the screw 525 may pass through the hook hole 5211 and be fastened to the stopper coupling portion 2144 so that the elastic hook 52 is fixed.

A hook insertion hole 5212 into which the hook coupling portion 2145 is inserted may be formed at a lateral side of the hook hole 5211. By the screw 525 and the hook coupling portion 2145, the elastic hook 52 may be firmly maintained in a fixed state without rotation.

Meanwhile, the elastic hook 52 may be formed to have a shape symmetrical in a vertical direction. That is, the elastic hook 52 may have identical front and rear shapes and may be configured to be mounted to both the first lower mounting portion 2141a and the second lower mounting portion 2141b.

The second lower mounting portion 2141b may have the same structure as the first lower mounting portion 2141a. That is, the guide member mounting groove 2142, the stopper coupling portions 2143 and 2144, the hook coupling portion 2145, and the fastening hole 2146 may also be formed at the second lower mounting portion 2141b. When the guide member 40 is mounted to the second lower mounting portion 2141b, the guide groove 400 formed at the second lower mounting portion 2141b may be referred to as a second guide groove 400 in order to distinguish it from the first guide groove 400.

Accordingly, the center hinge 32 may be selectively mounted to one of the first lower mounting portion 2141a and the second lower mounting portion 2141b, and may be selectively mounted according to a change in the opening and closing direction of the upper door 21. The guide member 40, the stopper 51, and the elastic hook 52 may be provided only at one of the first lower mounting portion 2141a and the second lower mounting portion 2141b to which the center hinge 32 is mounted.

That is, as illustrated in FIGS. 5 - 7, when the upper door 21 is opened and closed in the first direction, the guide member 40, the stopper 51, and the elastic hook 52 may be provided only at the first lower mounting portion 2141a. The center hinge 32 may be connected to the upper door 21 through the first lower mounting portion 2141a.

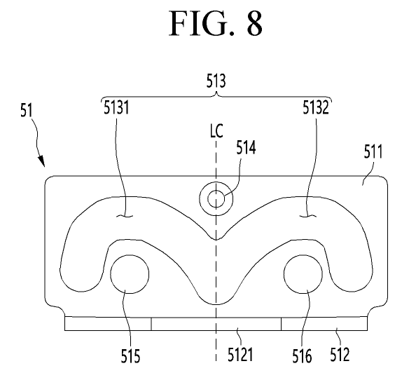

FIG. 8 is a plan view of the stopper.

Referring to the drawings, the stopper 51 will be described in more detail. The stopper 51 may be formed of a metal material. The stopper 51 may include a stopper plate 511 mounted to the lower cap 214 and a stopper bending portion 512 protruding downward from a front end of the stopper plate 511. A stopping part 5121 further protruding downward may be formed at the stopper bending portion 512. The stopping part 5121 may interfere with one side of the hinge plate 320 when the upper door 21 is fully opened, thereby restricting further opening of the upper door 21.

A stopper opening 513 may be further formed in the stopper plate 511. A pair of coupling holes 515 and 516 and a through-hole 514 may be formed in the stopper plate 511. The stopper plate 511 may be formed such that left and right sides thereof are symmetrical with respect to an extension line Lc passing through a center of the stopper 51.

In detail, the stopper opening 513 may be formed to pass through the stopper plate 511. The stopper opening 513 may include a first opening 5131 and a second opening 5132. The first opening 5131 and the second opening 5132 may be disposed symmetrically with respect to the extension line Lc, and end portions of the first opening 5131 and the second opening 5132 may be connected to each other to form a single opening.

The first opening 5131 may be formed in a shape corresponding to the guide member mounting groove 2142 formed at the first lower mounting portion 2141a. Accordingly, the guide member 40 may pass through the first opening 5131 and be mounted to the guide member mounting groove 2142. The first opening 5131 may also be formed in a shape corresponding to the first guide groove 400 of the first lower mounting portion 2141a.

The second opening 5132 may be formed symmetrically with the first opening 5131 with respect to the extension line Lc. Accordingly, the second opening 5132 may be formed in a shape corresponding to the guide member mounting groove 2142 formed at the second lower mounting portion 2141b. The second opening 5132 may also be formed in a shape corresponding to the second guide groove 400 of the second lower mounting portion 2141b.

The through-hole 514 may be positioned on the extension line Lc and may be located between the first opening 5131 and the second opening 5132.

The pair of coupling holes 515 and 516 may be formed to pass through the stopper plate 511 at left and right sides with respect to the extension line Lc. The pair of coupling holes 515 and 516 may be formed in a space between recessed portions of the first opening 5131 and the second opening 5132 and a front end of the stopper plate 511. The stopper coupling portions 2143 and 2144 may be inserted into the pair of coupling holes 515 and 516 so that the stopper 51 is aligned with the first lower mounting portion 2141a.

Meanwhile, the second lower mounting portion 2141b may be formed in a shape symmetrical to the first lower mounting portion 2141a with respect to a center of the upper door 21. That is, the guide member mounting groove 2142, the fastening hole 2146, the stopper coupling portions 2144 and 2143, and the hook coupling portion 2145 may be formed at the second lower mounting portion 2141b, although their orientations may be reversed. When the center hinge 32 is mounted to the second lower mounting portion 2141b according to a change in the opening and closing direction of the upper door 21, the guide member 40, the stopper 51, and the elastic hook 52 may be mounted to the second lower mounting portion 2141b.

The guide member 40 may be mounted to either the first lower mounting portion 2141a or the second lower mounting portion 2141b. In this case, the guide member 40 and the guide groove 400 mounted at the first lower mounting portion 2141a and the second lower mounting portion 2141b may have the same structure, although their shapes may be mirrored left and right with respect to the center of the upper door 21. Accordingly, hereinafter, the guide member 40 mounted to the first lower mounting portion 2141a will be described as an example.

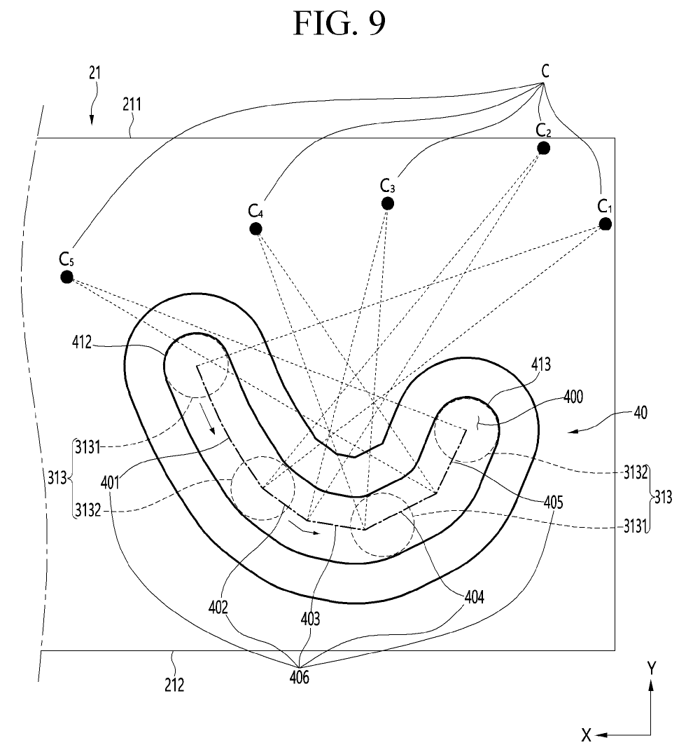

FIG. 9 is a plan view of the guide member.

Referring to the drawings, the guide member 40 will be described in detail. A hinge pin 313 of the center hinge 32 is inserted into the guide member 40, and the guide member 40 may provide a movement path along which the hinge pin 313 relatively moves during opening and closing movement of the upper door 21. The guide member 40 may be separately molded of a material having wear resistance and lubricity and then mounted to the lower cap 214. For example, the guide member 40 may be formed of an engineering plastic material.

The guide member 40 may include a pair of side portions 411 spaced apart from each other, and a first connecting portion 412 and a second connecting portion 413 connecting end portions of the pair of side portions 411. The side portions 411, the first connecting portion 412, and the second connecting portion 413 may define a guide groove 400 opened downward. The guide groove 400 may define a path along which the hinge pin 313 is inserted and moves. A width of the guide groove 400 may correspond to an outer diameter of the hinge pin 313. Accordingly, an outer surface of the hinge pin 313 may contact an inner surface of the guide groove 400, thereby allowing the pair of hinge pins 313 to move smoothly without lateral deviation.

In detail, a single guide groove 400 may define a path along which both hinge pins 313, that is, the first hinge pin 3131 and the second hinge pin 3132, move while inserted therein. The guide groove 400 may be formed by continuously arranging a plurality of paths 406 extending in different directions. That is, the hinge pin 313 may sequentially move along the plurality of paths 406 so that a position of the rotational center of the upper door 21 is changed, thereby allowing the upper door 21 to be opened and closed. Accordingly, the upper door 21 may move while rotating during the opening and closing process so as not to interfere with an adjacent wall, another refrigerator, or another home appliance.

For example, the guide groove 400 may include five paths 406. The paths 406 may extend in different directions and may have a structure in which the five paths 406 are continuously connected. The plurality of paths 406 may be formed in various shapes, such as a straight shape, a rounded shape having different curvatures, or an arc shape having different centers, and at least one or more of these shapes may be combined with each other.

A movement path of the hinge pin 313 may be determined by a shape of the guide groove 400, and a position of the rotational center of the upper door 21 may be shifted according to a position of the hinge pin 313 as it moves. That is, the rotational center of the upper door 21 does not refer to a single fixed axis, but may be understood as a virtual rotational center that varies depending on paths along which the first hinge pin 3131 and the second hinge pin 3132 move.

For example, the guide groove 400 may be composed of a plurality of paths 406 defined by a plurality of arcs having different centers C. That is, the guide groove 400 may be formed by continuously connecting a first path 401, a second path 402, a third path 403, a fourth path 404, and a fifth path 405. Centers C of the paths 406 may be positioned at different locations.

The first path 401 may be formed at one end of the guide groove 400. The first path 401 may be configured such that the hinge pin 313 is positioned therein when the upper door 21 is in a closed state. That is, the first hinge pin 3131 and the second hinge pin 3132 may be positioned at opposite ends of the first path 401. An extending direction of the first path 401 may correspond to an arrangement of the first hinge pin 3131 and the second hinge pin 3132. A length of the first path 401 may correspond to a distance between centers of the first hinge pin 3131 and the second hinge pin 3132.

Accordingly, the first path 401 may define a path along which the hinge pin 313 moves when the door 21 starts to open. That is, when the hinge pin 313 begins to move along the first path 401, the door 21 may start to open.

A first center C1, which is a center of an arc forming the first path 401, may be defined as an intersection point of a perpendicular line passing through a contact point between the first hinge pin 3131 and the guide groove 400 and a perpendicular line passing through a contact point between the second hinge pin 3132 and the guide groove 400.

The first center C1 may be positioned at a corner region between a front surface and a side surface of the upper door 21 so that, when opening of the upper door 21 begins, the upper door 21 does not interfere with a wall on which the refrigerator 1 is installed. The first center C1 may be located closest to the side surface of the upper door 21 among the centers C, that is, at a rightmost position in an x-axis direction in FIG. 9.

The second path 402 may extend rightward and rearward from an end of the first path 401. A length of an arc forming the second path 402 may be shorter than a length of the arc forming the first path 401. A second center C2, which is a center of the arc forming the second path 402, may be positioned more forward in a y-axis direction in FIG. 9 than the first center C1 and may be located farther from the side surface of the upper door 21 than the first center C1.

The third path 403 may extend rightward and rearward from an end of the second path 402. A length of an arc forming the third path 403 may be shorter than a length of the arc forming the second path 402. A third center C3, which is a center of the arc forming the third path 403, may be positioned forward of the first center C1 in the y-axis direction in FIG. 9 and rearward of the second center C2. The third center C3 may be located farther from the side surface of the upper door 21 than the second center C2.

The fourth path 404 may extend rightward and forward from an end of the third path 403. A length of an arc forming the fourth path 404 may be longer than lengths of arcs forming the second path 402 and the third path 403, and shorter than a length of the arc forming the first path 401. A fourth center C4, which is a center of the arc forming the fourth path 404, may be positioned forward of the first center C1 in the y-axis direction in FIG. 9 and rearward of the third center C3. The fourth center C4 may be located farther from the side surface of the upper door 21 than the third center C3.

The fifth path 405 may form the other end of the guide groove 400. The fifth path 405 may be configured such that the hinge pin 313 is positioned therein when the upper door 21 is in a fully opened state. In this case, a length of the fifth path 405 may be smaller than a distance between centers of the first hinge pin 3131 and the second hinge pin 3132.

The fifth path 405 may extend rightward and forward from an end of the fourth path 404. Both the fifth path 405 and the first path 401 may extend forward, and the first path 401 may extend farther forward than the fifth path 405.

A length of an arc forming the fifth path 405 may be longer than lengths of arcs forming the second path 402 and the third path 403, and shorter than the length of the arc forming the first path 401. A fifth center C5, which is a center of the arc forming the fifth path 405, may be positioned rearward of the first center C1 and may be located at a rearmost position among the centers C. The fifth center C5 may be located farther from the side surface of the upper door 21 than the fourth center C4. That is, the first center C1 to the fifth center C5 may be sequentially positioned farther away from the side surface of the upper door 21. Accordingly, the guide groove 400 may allow movement of the hinge pin 313 to be smoother and may enable smooth rotational opening and closing operation of the upper door 21.

As described above, the first hinge pin 3131 and the second hinge pin 3132 move along the paths 406 of the guide member 40, thereby rotating the upper door 21. The upper door 21 may be opened and closed while its rotational center changes, and during the opening and closing process, an end portion of the upper door 21 may be prevented from protruding laterally beyond the cabinet 10 and contacting a wall at a side of the refrigerator 1. Accordingly, even when the refrigerator 1 is installed very close to an adjacent wall surface, rotation of the door 21 may be ensured without interference during opening and closing operation.

Meanwhile, a specific shape of the guide groove 400 may vary depending on a size of the upper door 21 and an amount of protrusion of the upper door 21 during opening and closing, and the guide groove 400 may be formed by continuously arranging a plurality of paths extending in different directions.

The fourth path 404 may extend rightward and forward from an end of the third path 403. A length of an arc forming the fourth path 404 may be longer than lengths of arcs forming the second path 402 and the third path 403, and shorter than a length of the arc forming the first path 401. A fourth center C4, which is a center of the arc forming the fourth path 404, may be positioned forward of the first center C1 in the y-axis direction in FIG. 9 and rearward of the third center C3. The fourth center C4 may be located farther from the side surface of the upper door 21 than the third center C3.

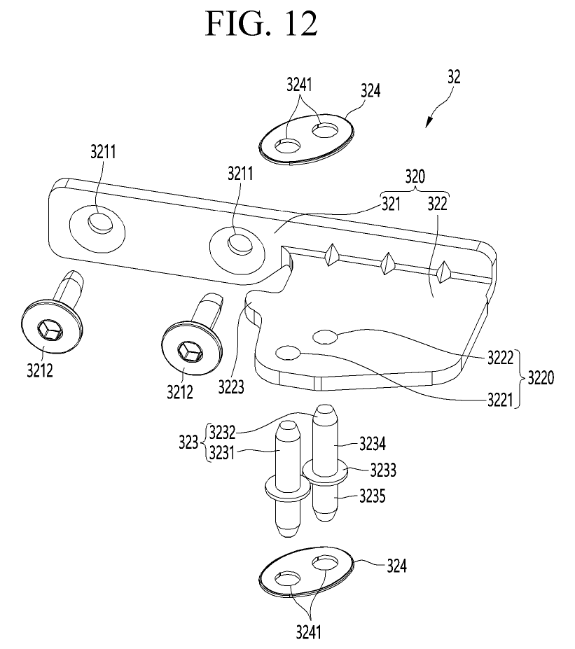

FIG. 10 is a perspective view of a center hinge coupled to the door openable in the first direction, and FIG. 11 is a front view of the center hinge, and FIG. 12 is an exploded perspective view of the center hinge.

As illustrated, the center hinge 32 may include a hinge plate 320 fixed to the cabinet 10 and the hinge pin 313.

The hinge plate 320 may be formed of a metal material. The hinge plate 320 may include a plate fixing portion 321 coupled to the cabinet 10 and a plate extension portion 322 provided with the hinge pin 313. The plate fixing portion 321 and the plate extension portion 322 may intersect with each other. The plate extension portion 322 may be integrally formed with the plate fixing portion 321 or may be bent from the plate fixing portion 321.

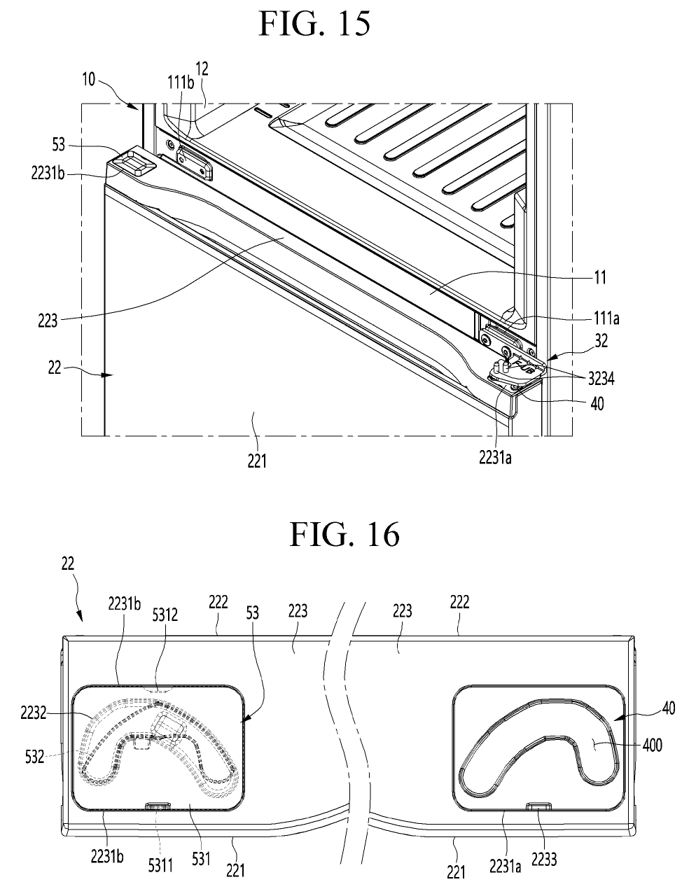

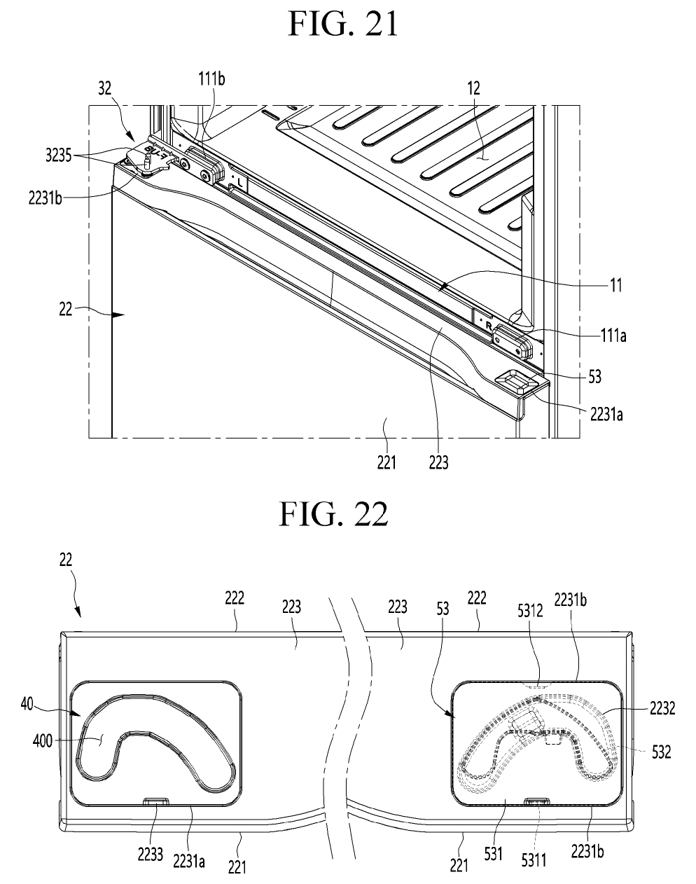

The plate fixing portion 321 may be formed in a plate shape and may contact a front surface of the cabinet 10. A fastening hole 3211 may be formed at one side of the plate fixing portion 321 with respect to a center thereof, for example, at a left side in FIGS. 10 and 11. The fastening holes 3211 may be spaced apart from each other in a left-right direction, and fastening members 3212 may be fastened thereto so that the hinge plate 320 is coupled to the cabinet 10. The plate fixing portion 321 may be mounted to one of a first cabinet mounting portion 111a and a second cabinet mounting portion 111b formed on the front surface of the cabinet 10 according to an opening and closing direction of the upper door 21, as illustrated in FIGS. 15 and 21.

The fastening holes 3211 may be positioned at a midpoint of a vertical height H1 of the plate fixing portion 321 and may be spaced apart from each other in a left-right direction. The pair of fastening holes 3211 may be arranged on the extension line Lc passing through the midpoint of the vertical height of the plate fixing portion 321.

The plate extension portion 322 may be formed at the other side of the plate fixing portion 321 with respect to a center thereof, for example, at a right side in FIGS. 10 and 11. The plate extension portion 322 may extend forward from a lateral end of the plate fixing portion 321. In this case, a left-right length L2 of the plate extension portion 322 may be equal to a length L1 from an end of the plate extension portion 322 to an end of the plate fixing portion 321. That is, the left-right length L2 of the plate extension portion 322 may be equal to one-half L1 of a left-right length of the plate fixing portion 321.

The plate extension portion 322 may be positioned on the extension line Lc passing through a midpoint of a vertical height of the plate fixing portion 321. That is, the plate extension portion 322 and the fastening holes 3211 may be arranged on the same extension line of the plate fixing portion 321. A height H2 from a center of the plate extension portion 322 to an upper end of the plate fixing portion 321 may be smaller than a total vertical height of the plate fixing portion 321. For example, the height H2 to the upper end of the plate fixing portion 321 may be one-half of the vertical height of the plate fixing portion 321.

Accordingly, the center hinge 32 may be mounted in a normal orientation or in an inverted orientation, and may be mounted to both the first lower mounting portion 2141a and the second lower mounting portion 2141b. That is, a single center hinge 32 may be mounted to either a left side or a right side of the upper door 21 according to the opening and closing direction of the upper door 21.

A locking portion 3223 may protrude from an outer surface of the plate extension portion 322. The locking portion 3223 may be configured to be restrained by the elastic hook 52 when the upper door 21 is in a closed state. An outer end of the plate extension portion 322 may extend so as to contact the stopping part 5121 when the upper door 21 is fully opened.

Pin holes 3220 penetrating the plate extension portion 322 may be formed so that the hinge pin 313 is mounted thereto. The pin holes 3220 may include a first pin hole 3221 to which the first hinge pin 3131 is mounted and a second pin hole 3222 to which the second hinge pin 3132 is mounted.

The hinge pin 313 may include a first hinge pin 3131 and a second hinge pin 3132. The first hinge pin 3131 and the second hinge pin 3132 may be formed in identical shapes. For example, the second hinge pin 3132 may be positioned farther from a center of the upper door 21 than the first hinge pin 3131, that is, closer to a front surface of the upper door 21. The first hinge pin 3131 and the second hinge pin 3132 may have an arrangement structure such that both are inserted into the guide groove 400.

Each of the first hinge pin 3131 and the second hinge pin 3132 may include a pin upper portion 3234 protruding upward from the plate extension portion 322 and a pin lower portion 3235 protruding downward from the plate extension portion 322. Accordingly, the pin upper portion 3234 may be inserted into the guide groove 400 of the upper door 21, and the pin lower portion 3235 may be inserted into the guide groove 400 of the lower door 22, so that the upper door 21 and the lower door 22 may be independently opened and closed.

A pin protrusion 3233 protruding outward along a circumference of the hinge pin 313 may be formed between the pin upper portion 3234 and the pin lower portion 3235. The pin protrusion 3233 may contact a lower surface of the plate extension portion 322 so that the hinge pin 313 is inserted to an accurate depth.

A contact member 324 may be provided on the hinge pin 313. The contact member 324 may be formed in a plate shape and may include through-holes 3241 through which the first hinge pin 3131 and the second hinge pin 3132 pass. The contact member 324 may contact an end of the guide member 40 in a state mounted to the hinge pin 313. Accordingly, during repeated opening and closing of the upper door 21, the hinge pin 313 may be prevented from locally contacting the guide member 40 and causing wear of the guide member 40. The contact member 324 may be provided at each of the pin upper portion 3234 and the pin lower portion 3235, and may respectively contact the guide member 40 of the upper door 21 and the guide member 40 of the lower door 22.

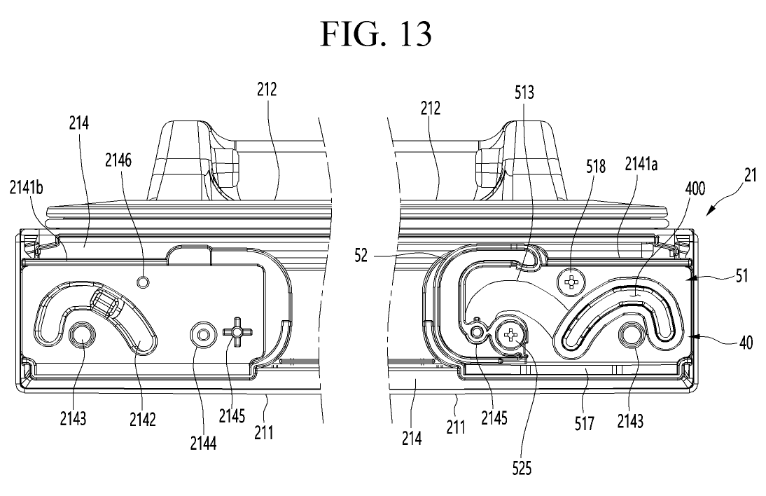

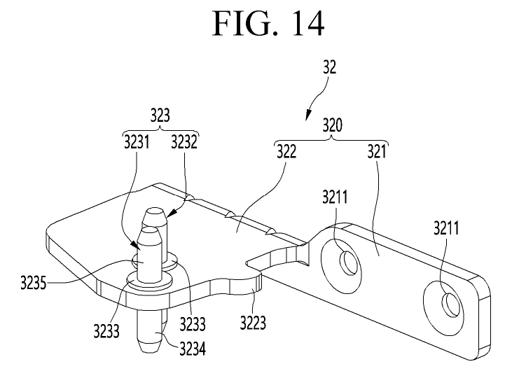

FIG. 13 is a bottom view of the door openable in the second direction, and FIG. 14 is a perspective view of the center hinge coupled to the door openable in the second direction.

As illustrated, when an opening and closing direction of the upper door 21 is changed to the second direction, the center hinge 32 may be mounted to the second cabinet mounting portion 111b (see FIG. 21). In this case, the center hinge 32 mounted to the first cabinet mounting portion 111a may be inverted and reused as it is.

That is, the center hinge 32 may be mounted to the second cabinet mounting portion 111b on the front surface of the cabinet 10. In this case, the center hinge 32 may be arranged such that the pin lower portion 3235 faces upward. Due to structural characteristics of the center hinge 32, even when mounted in an inverted orientation to the second cabinet mounting portion 111b, a height and position of the hinge pin 313 may be maintained so that the center hinge 32 remains connectable to both the upper door 21 and the lower door 22.

For coupling with the center hinge 32, the stopper 51 and the elastic hook 52 may be mounted to the second lower mounting portion 2141b. The guide member 40 may be inserted and mounted into the guide member mounting groove 2142. In this case, the guide member 40 may pass through the second opening 5132 formed in the stopper 51 and be inserted into the guide member mounting groove 2142.

Conversely, the stopper 51 and the elastic hook 52 may not be mounted to the first lower mounting portion 2141a to which the center hinge 32 is not mounted. For mounting of the center hinge 32, the stopper 51 and the elastic hook 52 mounted to the first lower mounting portion 2141a may be detached and mounted to the second lower mounting portion 2141b. Accordingly, when the center hinge 32 is relocated to change the opening and closing direction of the upper door 21, the stopper 51 and the elastic hook 52 may also be relocated together.

Meanwhile, the center hinge 32 may be coupled to an upper end of the lower door 22.

A coupling structure between the lower door 22 and the center hinge 32 will be described in more detail with reference to the drawings.

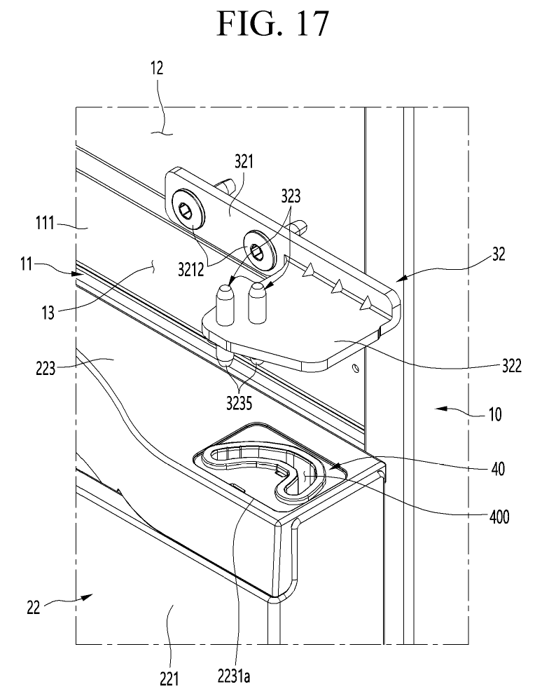

FIG. 15 is a perspective view illustrating the door openable in the first direction coupled with the center hinge, and FIG. 16 is an exploded perspective view illustrating the door openable in the first direction and the center hinge separated from each other, and FIG. 17 is an exploded perspective view illustrating the door and a guide cover separated from each other.

As illustrated, the lower door 22 may include a front panel 221 forming a front surface, a door liner 222 forming a rear surface, an upper cap 223 forming an upper surface, and a lower cap 224 forming a lower surface. An insulation material may be filled inside the lower door 22 formed by coupling the front panel 221, the door liner 222, the upper cap 223, and the lower cap 224. For distinction from the upper door 21, the front panel 221 may be referred to as a lower door front panel 221, the door liner 222 as a lower door door liner 222, the upper cap 223 as a lower door upper cap 223, and the lower cap 224 as a lower door lower cap 224.

For rotation of the lower door 22, the center hinge 32 may be connected to one end of the upper cap 223.

In detail, first and second upper mounting portions 2131a and 2131b may be formed at left and right sides of the upper cap 223. The first upper mounting portion 2131a and the second upper mounting portion 2131b may have identical structures and may be arranged symmetrically with respect to a center of the lower door 22.

A guide member mounting groove 2232 to which the guide member 40 is mounted may be formed at the first upper mounting portion 2131a. In a state in which the guide member 40 is mounted in the guide member mounting groove 2232, the guide groove 400 may be exposed upward. The guide member 40 may have the same structure as the guide member 40 mounted to the upper door 21. The guide groove 400 of the first upper mounting portion 2131a may be referred to as a first guide groove 400 to distinguish it from the guide groove 400 of the second upper mounting portion 2131b.

A cover fixing portion 2233 for fixing a guide cover 53 may be formed at the first upper mounting portion 2131a. The cover fixing portion 2233 may be coupled with a cover protrusion 5311 of the guide cover 53 so that the guide cover 53 is fixed to the first upper mounting portion 2131a.

The guide member mounting grooves 2232 formed in the first upper mounting portion 2131a and the second upper mounting portion 2131b may be formed symmetrically with respect to a center of the lower door 22. Accordingly, the center hinge 32 may be mounted to one of the first upper mounting portion 2131a and the second upper mounting portion 2131b, and the guide cover 53 may be mounted to the other one.

The guide groove 400 of the second upper mounting portion 2131b may be referred to as a second guide groove 400 to distinguish it from the guide groove 400 of the first upper mounting portion 2131a.

For example, as illustrated in FIGS. 15 - 17, when the lower door 22 is mounted to be opened and closed in the first direction, the center hinge 32 may be mounted to the first upper mounting portion 2131a. In this case, the hinge pin 313 of the center hinge 32 may be inserted into the guide groove 400 of the guide member 40 provided at the first upper mounting portion 2131a.

The pin lower portion 3235 may be inserted into the guide groove 400, and during opening and closing of the lower door 22, the pin lower portion 3235 may move along the guide groove 400 so that the lower door 22 moves along a predetermined trajectory.

The guide cover 53 may be mounted to the second upper mounting portion 2131b that is not coupled with the center hinge 32. The guide cover 53 may cover the guide member mounting groove 2232 of the second upper mounting portion 2131b. Accordingly, the second upper mounting portion 2131b to which the center hinge 32 is not mounted may be prevented from being exposed.

The first upper mounting portion 2131a and the second upper mounting portion 2131b may be recessed to correspond to a size of the guide cover 53. In a state in which the guide cover 53 is mounted, a portion of the upper surface of the lower door 22 may be formed by the guide cover 53. In addition, when the guide cover 53 is mounted, the first upper mounting portion 2131a or the second upper mounting portion 2131b may not be exposed to the outside.

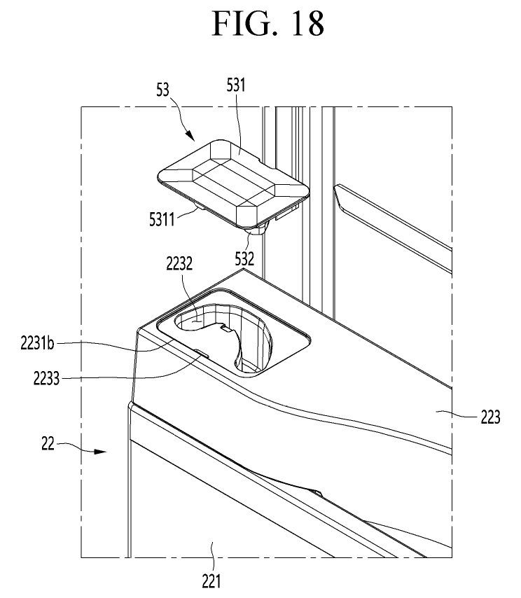

FIG. 18 is a top view of the door openable in the first direction, and

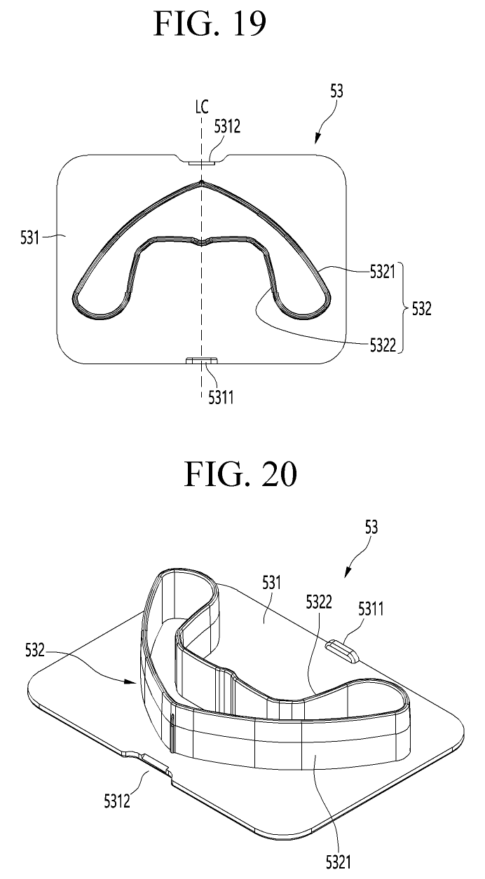

FIG. 19 is a plan view of the guide cover, and FIG. 20 is a perspective view of the guide cover as viewed from below.

As illustrated, the guide cover 53 may have a structure mountable to both the first upper mounting portion 2131a and the second upper mounting portion 2131b. That is, a single guide cover 53 may be selectively mounted to either the first upper mounting portion 2131a or the second upper mounting portion 2131b. Further, the guide cover 53 mounted to one of the first upper mounting portion 2131a and the second upper mounting portion 2131b may be detached and mounted to the other one.

The guide cover 53 may be formed of a plastic material. For example, the guide cover 53 may be formed of the same material as the upper cap 223. The guide cover 53 may include a cover plate 531 and a cover insertion portion 532.

The cover plate 531 may be formed in a plate shape and may have a size corresponding to the second upper mounting portion 2131b. The cover plate 531 may correspond to a recessed depth of the second upper mounting portion 2131b. Accordingly, when the cover plate 531 is mounted, the second upper mounting portion 2131b may be shielded, and the cover plate 531 may be exposed to form a same plane as an upper surface of the upper cap 223.

A cover insertion portion 532 protruding downward may be formed on a lower surface of the cover plate 531. The cover insertion portion 532 may be formed to be insertable into the guide member mounting groove 2232. The cover insertion portion 532 may be formed symmetrically at left and right sides with respect to the extension line Lc passing through a center of the guide cover 53. The cover insertion portion 532 may have a shape mountable to both the guide member mounting grooves 2232 formed in the first upper mounting portion 2131a and the second upper mounting portion 2131b. The cover insertion portion 532 may also have a shape insertable into the guide groove 400.

For example, a circumferential surface of the cover insertion portion 532 may include a first circumferential portion 5321 and a second circumferential portion 5322. In detail, the first circumferential portion 5321 may form a surface of the circumferential surface of the cover insertion portion 532 that faces relatively rearward. The second circumferential portion 5322 may form a surface of the circumferential surface of the cover insertion portion 532 that faces forward.

The first circumferential portion 5321 and the second circumferential portion 5322 may be connected to each other to form the circumferential surface of the cover insertion portion 532. One end of the first circumferential portion 5321 and one end of the second circumferential portion 5322 may be connected to each other, and the other end of the first circumferential portion 5321 and the other end of the second circumferential portion 5322 may be positioned on the extension line Lc. That is, the first circumferential portion 5321 and the second circumferential portion 5322 may be arranged symmetrically at left and right sides with respect to the extension line Lc. By the first circumferential portion 5321 and the second circumferential portion 5322 connected to each other, the cover insertion portion 532 may protrude downward.

The first circumferential portion 5321 may have a curvature corresponding to a rearward-facing surface at one of left and right sides with respect to a center of the guide member mounting groove 2232, and may be in close contact therewith. The second circumferential portion 5322 may have a curvature corresponding to a forward-facing surface at the other of left and right sides with respect to the center of the guide member mounting groove 2232, and may be in close contact therewith.

For example, as illustrated in FIG. 18, when the guide cover 53 is mounted to the second upper mounting portion 2131b, the cover insertion portion 532 may be inserted into the guide member mounting groove 2232. In this case, the first circumferential portion 5321 may contact a forward-facing surface at a right side with respect to the center of the guide member mounting groove 2232, and the second circumferential portion 5322 may contact a rearward-facing surface at a left side with respect to the center of the guide member mounting groove 2232.

Accordingly, the circumferential surface of the cover insertion portion 532 may be in surface contact with an inner surface of the guide member mounting groove 2232 so that the guide cover 53 is maintained in a mounted state at the second upper mounting portion 2131b. The guide cover 53 may also be mounted to the first upper mounting portion 2131a, and the circumferential surface of the cover insertion portion 532 may be mounted to contact an inner surface of the guide member mounting groove 2232.

A cover protrusion 5311 may protrude downward from one end of the cover plate 531. An end of the cover protrusion 5311 may be formed in a hook shape and may be restrained by the cover fixing portion 2233. Accordingly, by insertion and engagement of the cover protrusion 5311 with the cover fixing portion 2233, the guide cover 53 may be more firmly mounted to the first upper mounting portion 2131a.

A cover recess 5312 may be recessed at the other end of the cover plate 531 opposite to the cover protrusion 5311. The cover recess 5312 may be recessed to allow manipulation when separating the guide cover 53 mounted to the first upper mounting portion 2131a.

Meanwhile, when the opening and closing direction of the lower door 22 is changed, the center hinge 32 and the guide cover 53 may be mounted at different positions on an upper surface of the lower door 22.

FIG. 21 is a perspective view illustrating the door openable in the second direction coupled with the center hinge, and FIG. 22 is a top view of the door openable in the second direction.

As illustrated, in order to change the opening and closing direction of the lower door 22 to the second direction, the center hinge 32 may be mounted to the second upper mounting portion 2131b. For insertion and mounting of the hinge pin 313, the guide member 40 may be inserted and mounted into the guide member mounting groove 2232 of the second upper mounting portion 2131b.

The center hinge 32 may be detached from the first upper mounting portion 2131a and then mounted to the second cabinet mounting portion 111b of the cabinet 10 in an inverted orientation in a vertical direction. In this case, the hinge pin 313 of the center hinge 32 may be inserted into the guide groove 400 of the guide member 40 provided at the second upper mounting portion 2131b.

In a state in which the center hinge 32 is mounted to the second cabinet mounting portion 111b, the hinge pin 313 may be respectively inserted into and connected to the upper door 21 and the lower door 22.

The guide cover 53 mounted to the second upper mounting portion 2131b may be detached and mounted again to the first upper mounting portion 2131a. In this case, the cover insertion portion 532 may be formed symmetrically in left and right directions with respect to a center thereof and may be inserted and mounted into the guide member mounting groove 2232 of the first upper mounting portion 2131a by the structure of the first circumferential portion 5321 and the second circumferential portion 5322.

Hereinafter, a structure of the lower hinge and a coupling structure thereof will be described with reference to the drawings.

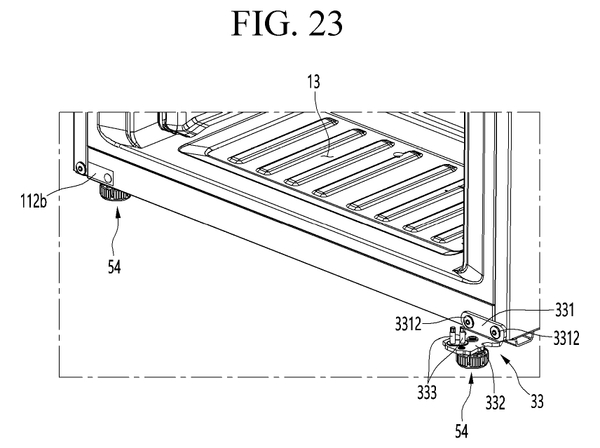

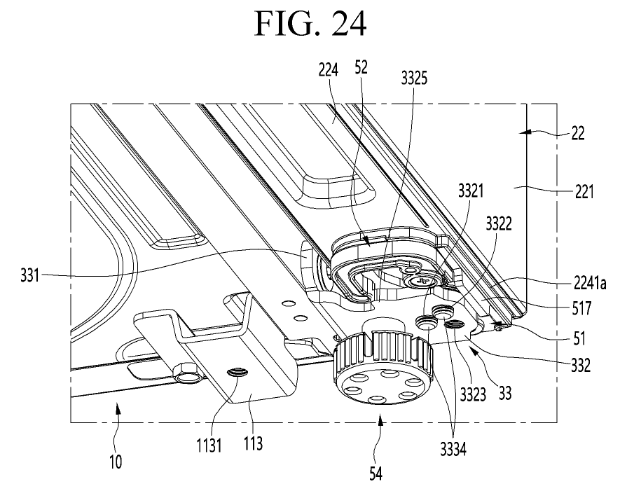

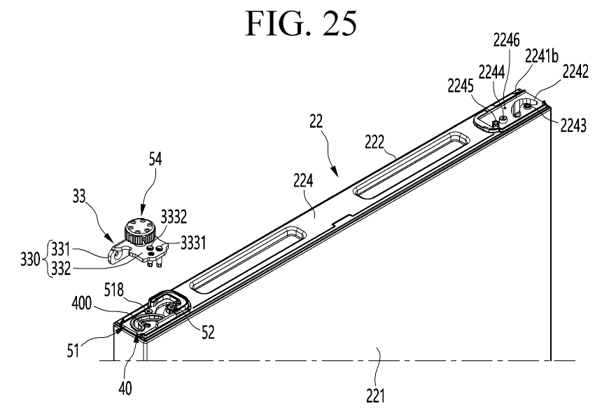

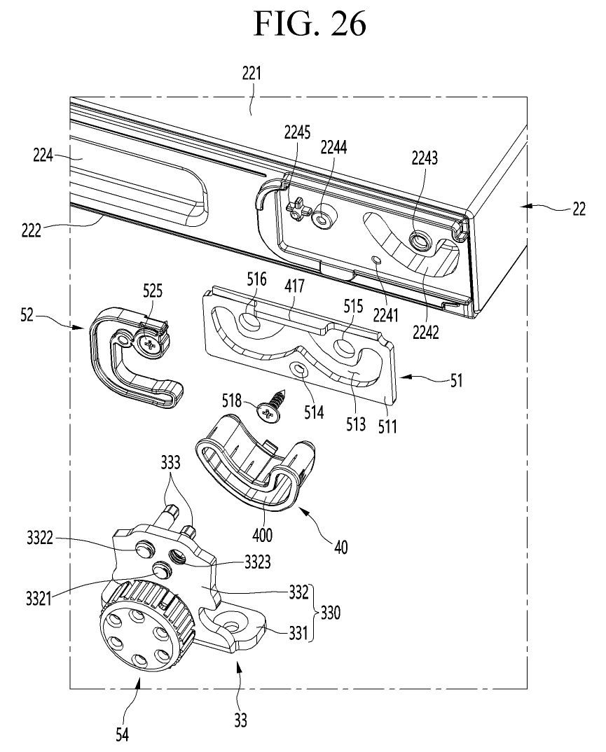

FIG. 23 is a perspective view illustrating a lower hinge mounted such that the door is opened in the first direction, and FIG. 24 is a perspective view illustrating the door openable in the first direction coupled with the lower hinge, and FIG. 25 is an exploded perspective view illustrating the door and the lower hinge separated from each other, and FIG. 26 is an exploded perspective view illustrating the stopper, the guide member, the lower hinge, and the elastic hook separated from the door.

As illustrated, a lower hinge 33 supporting the lower door 22 from below may be provided at a lower end of the cabinet 10. The lower hinge 33 may be connected to the lower door 22. A rotation direction of the lower door 22 in the first direction or the second direction may be determined according to a mounting position of the lower hinge 33.

That is, according to the opening and closing direction of the lower door 22, the lower hinge 33 may be mounted to one of a first cabinet mounting portion 112a formed at a left side of the cabinet 10 and a second cabinet mounting portion 112b formed at a right side thereof. The first cabinet mounting portion 112a and the second cabinet mounting portion 112b may also be referred to as a first lower cabinet mounting portion and a second lower cabinet mounting portion.

Fastening members 3312 passing through the lower hinge 33 may be fastened to the first cabinet mounting portion 112a and the second cabinet mounting portion 112b. In this case, a single lower hinge 33 may be selectively mounted to either the first cabinet mounting portion 112a or the second cabinet mounting portion 112b.

As illustrated in FIG. 8, when the lower door 22 is opened and closed in the first direction, the lower hinge 33 may be mounted to the first cabinet mounting portion 112a. A leg coupling portion 113 may be formed at a lower surface of the cabinet 10 corresponding to the second cabinet mounting portion 112b, and a leg 54 may be mounted to a coupling hole 1131 of the leg coupling portion 113. A leg 54 may also be mounted to the lower hinge 33 mounted to the first cabinet mounting portion 112a, and the cabinet 10 may be supported on the ground by the legs 54 provided at both left and right sides.

First and second lower mounting portions 2241a and 2241b for mounting the lower hinge 33 may be formed at left and right sides of a lower surface of the lower cap 224 of the lower door 22. The first lower mounting portion 2241a and the second lower mounting portion 2241b may also be referred to as a third lower mounting portion and a fourth lower mounting portion to distinguish them from those of the upper door.

The first lower mounting portion 2241a and the second lower mounting portion 2241b may have structures identical to those of the first lower mounting portion 2141a and the second lower mounting portion 2141b formed in the upper door 21. That is, the first lower mounting portion 2241a and the second lower mounting portion 2241b may be formed symmetrically in left and right directions with respect to a center of the lower door 22.

For example, a guide member mounting groove 2242 into which the guide member 40 is inserted and mounted may be formed in the first lower mounting portion 2241a. Stopper coupling portions 2243 and 2244 for mounting the stopper 51 may protrude from the first lower mounting portion 2241a. The stopper coupling portions 2243 and 2244 may be provided as a pair spaced apart in left and right directions. A fastening hole 2246 into which a screw 518 passing through the stopper 51 is fastened may be formed in the first lower mounting portion 2241a. A hook coupling portion 2245 for fixing the elastic hook 52 may further be formed in the first lower mounting portion 2241a. The elastic hook 52 may be fixed to the first lower mounting portion 2241a by a screw 525.

Accordingly, the guide member 40, the stopper 51, and the elastic hook 52 may be mounted to the first lower mounting portion 2241a, and a hinge pin 333 of the lower hinge 33 may be inserted into the guide groove 400 of the guide member 40. The guide groove 400 located at the first lower mounting portion 2241a may be referred to as a first guide groove 400 in order to distinguish it from the guide groove 400 located at the second lower mounting portion 2241b.

The second lower mounting portion 2241b may have the same structure as the first lower mounting portion 2241a. However, since the lower hinge 33 is not mounted to the second lower mounting portion 2241b, the guide member 40, the stopper 51, and the elastic hook 52 may be omitted.

Meanwhile, the first lower mounting portion 2241a and the second lower mounting portion 2241b may have the same structure as the corresponding lower mounting portions formed in the lower cap 224 of the lower door 22. The stopper 51 and the elastic hook 52 may also have identical structures. Accordingly, detailed descriptions thereof will be omitted.

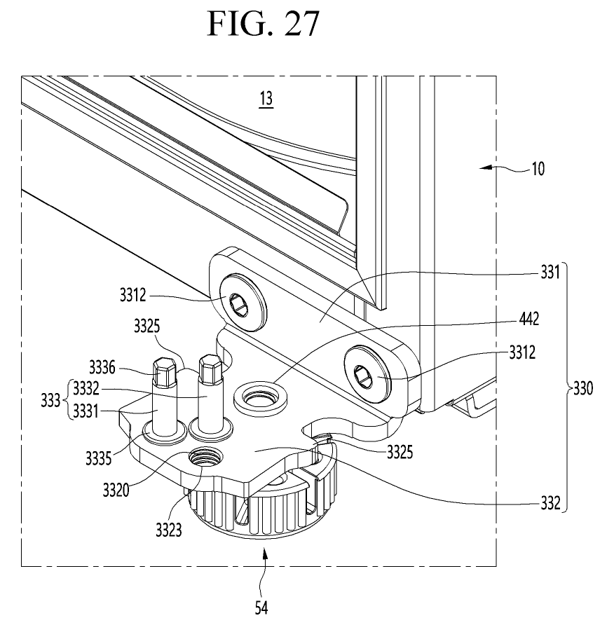

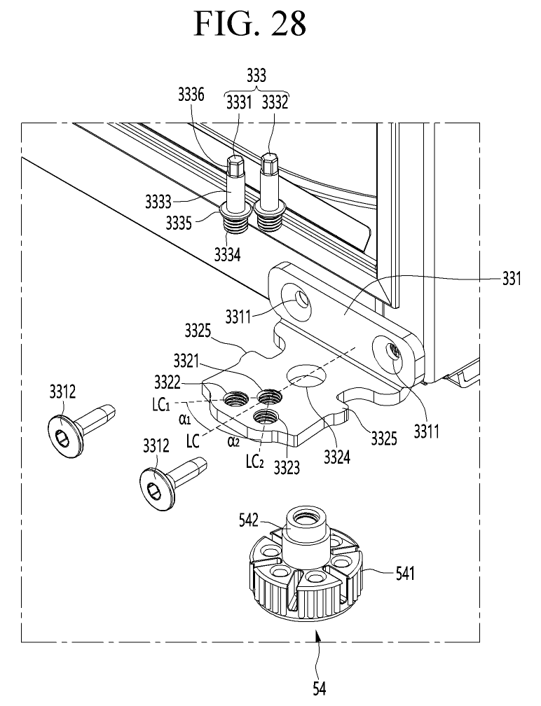

FIG. 27 is a perspective view of the lower hinge coupled to the door openable in the first direction, and FIG. 28 is an exploded perspective view of the lower hinge.

The lower hinge 33 may include a hinge plate 330 fixedly mounted to the cabinet 10 and a pair of hinge pins 333 provided on the hinge plate 330. The hinge plate 330 may be formed of a metal material, may protrude forward from a front surface of the cabinet 10, and may be positioned below a lower end of the lower door 22.

In detail, the hinge plate 330 may include a plate fixing portion 331 and a plate extension portion 332. The hinge plate 330 may also be referred to as a lower hinge plate. The plate fixing portion 331 and the plate extension portion 332 may also be referred to as a lower plate fixing portion and a lower plate extension portion, respectively.

The lower plate fixing portion 331 may be mounted to a front surface of the cabinet 10, that is, to the first cabinet mounting portion 112a. The plate fixing portion 331 may form a surface parallel to the front surface of the cabinet 10 and may be in surface contact with the front surface of the cabinet 10. Fastening holes 3311 through which fastening members 3312 pass may be formed in the plate fixing portion 331. The fastening holes 3311 may be provided as a pair spaced apart from each other.

The plate extension portion 332 may extend forward from a lower end of the plate fixing portion 331. The plate extension portion 332 may be integrally formed with the plate fixing portion 331 and may be formed by vertical bending.

The plate extension portion 332 may extend below the first lower mounting portion 2241a. The pair of hinge pins 333 provided on the plate extension portion 332 may be inserted into the guide groove 400 of the guide member 40. The hinge pins 333 may include a first hinge pin 3331 and a second hinge pin 3332, which may also be referred to as a first lower hinge pin and a second lower hinge pin.

Each hinge pin 333 may include a pin insertion portion 3334 inserted into the plate extension portion 332, a pin protrusion portion 3335 protruding outward from an upper end of the pin insertion portion 3334, and a pin body 3333 extending upward from the pin protrusion portion 3335 and inserted into the guide groove 400. An operation portion 3336 for rotating the hinge pin 333 may be formed at an upper end of the pin body 3333.

Threads may be formed on an outer surface of the pin insertion portion 3334 so that the hinge pin 333 may be detachably coupled to the hinge plate 330 in a screw manner. The pin protrusion portion 3335 may contact an upper surface of the plate extension portion 332. An upper end of the operation portion 3336 may have a structure allowing rotational manipulation by a dedicated tool, so that the hinge pin 333 is rotated and coupled to the plate extension portion 332.

The first hinge pin 3331 and the second hinge pin 3332 may be formed in identical shapes and may be arranged such that both are insertable into the guide groove 400. An arrangement of the hinge pins 333 may be identical to that of the hinge pins 313 of the center hinge 32.

Meanwhile, the lower hinge 33 may be formed in a shape symmetrical in left and right directions with respect to an extension line Lc passing through a center of the lower hinge 33. Accordingly, the lower hinge 33 may be selectively mounted to either the first cabinet mounting portion 112a or the second cabinet mounting portion 112b.

In detail, the fastening holes 3311 may be disposed at equal distances on left and right sides with respect to the extension line Lc. A shape of the plate extension portion 332 may also be symmetrical in left and right directions with respect to the extension line Lc.

For example, a locking portion 3325 engaged with the elastic hook 52 may be formed at a side surface of the plate extension portion 332, and a perimeter of the plate extension portion 332 including the locking portion 3325 may be formed symmetrically with respect to the extension line Lc.

A leg hole 3324 into which the leg 54 is mounted may be formed in the plate extension portion 332. The leg hole 3324 may be formed to penetrate the plate extension portion 332 and may be positioned on the extension line Lc. The leg 54 may be detachably coupled to the leg hole 3324.

The leg 54 may include a cylindrical leg body 541 supported on the ground and a leg shaft 542 provided at a center of the leg body 541. Threads may be formed on an outer surface of the leg shaft 542 and on an inner surface of the leg hole 3324 so as to be engaged with each other. Accordingly, a height of the leg 54 may be adjusted.

Meanwhile, pin holes 3321, 3322, and 3323 into which the hinge pins 333 are inserted may be formed in the plate extension portion 332. Three pin holes may be formed, and the hinge pins 333 may be selectively mounted according to a mounting position of the lower hinge 33.

For example, threads 3320 may be formed on inner surfaces of the pin holes 3321, 3322, and 3323 and may be engaged with threads formed on the outer surface of the pin insertion portion 3334. That is, the hinge pins 333 may be selectively mounted to a plurality of the pin holes 3321, 3322, and 3323 and may be coupled to and separated from the plate extension portion 332 in a screw manner.

n detail, the pin holes 3321, 3322, and 3323 may be positioned at a central region of the plate extension portion 332, and a plurality thereof may be arranged symmetrically with respect to the extension line Lc. The pin holes 3321, 3322, and 3323 may include a first pin hole 3321, a second pin hole 3322, and a third pin hole 3323.

The first pin hole 3321 may be positioned most rearward among the pin holes 3321, 3322, and 3323 and may be arranged such that a center thereof is located on the extension line Lc. The second hinge pin 3332 may always be coupled to the first pin hole 3321 regardless of a mounting position of the lower hinge 33.

The second pin hole 3322 may be formed more forward than the first pin hole 3321 and may be positioned laterally spaced apart from the extension line Lc. A first extension line Lc1 connecting a center of the second pin hole 3322 and a center of the first pin hole 3321 may have a predetermined angle α1.

The third pin hole 3323 may be formed more forward than the first and second pin holes 3321 and 3322 and may be positioned laterally spaced apart from the extension line Lc. A second extension line Lc2 connecting a center of the third pin hole 3323 and the center of the first pin hole 3321 may have a predetermined angle α2.

The second pin hole 3322 and the third pin hole 3323 may be spaced forward from the first pin hole 3321 by an equal distance. The second pin hole 3322 and the third pin hole 3323 may be positioned on opposite sides with respect to the extension line Lc. The respective predetermined angles formed by the first extension line Lc1 and the second extension line Lc2 may be identical. That is, the second pin hole 3322 and the third pin hole 3323 may be arranged in a rotationally symmetric manner about the center of the first pin hole 3321.

In this case, the arrangement of the second pin hole 3322 and the third pin hole 3323 may be determined according to a shape of the guide groove 400 so that the first hinge pin 3331 and the second hinge pin 3332 are movable in a state inserted into the guide groove 400.

The first hinge pin 3331 may be selectively mounted to either the second pin hole 3322 or the third pin hole 3323 according to the mounting position of the lower hinge 33. For example, as illustrated in FIG. 27, when the lower door 22 is opened in the first direction, the lower hinge 33 may be mounted to the first lower mounting portion 2241a.

In this case, the second hinge pin 3332 may be coupled to the first pin hole 3321, and the first hinge pin 3331 may be coupled to the second pin hole 3322. The first hinge pin 3331 and the second hinge pin 3332, in a state coupled to the plate extension portion 332, may be inserted into the guide groove 400. Accordingly, the lower hinge 33 may be connected to a right side of a lower surface of the lower door 22, thereby allowing the lower door 22 to be opened and closed in the first direction.

Meanwhile, the lower door 22 may be configured to be opened and closed in the second direction. The opening and closing direction of the lower door 22 may be changed by relocating and mounting the lower hinge 33 to the second cabinet mounting portion 112b.

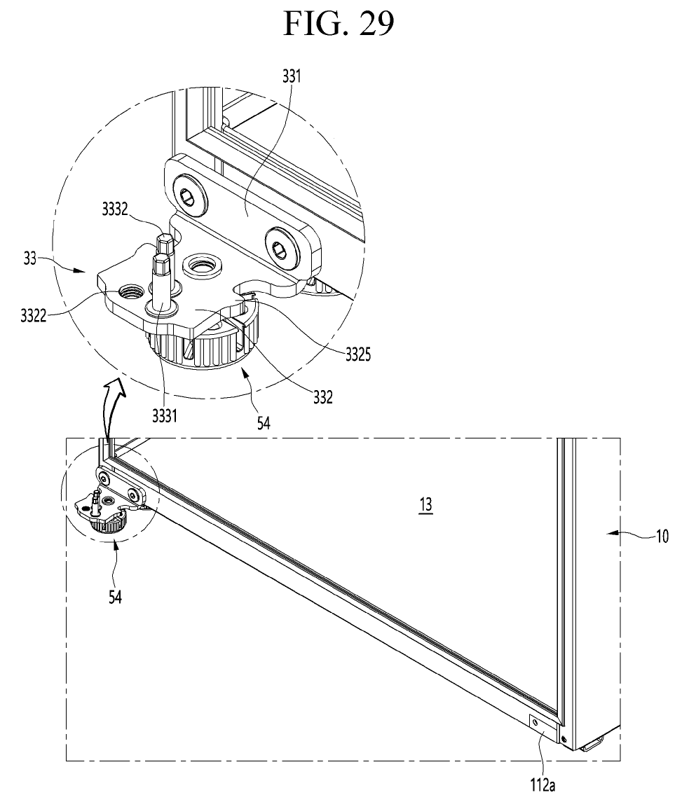

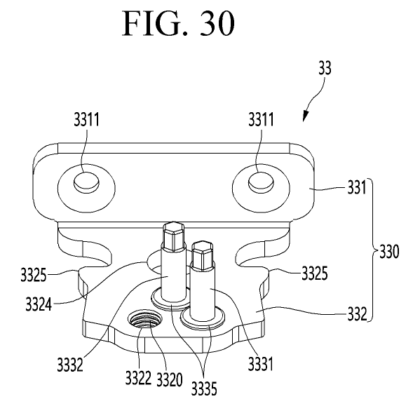

FIG. 29 is a perspective view illustrating the lower hinge mounted such that the door is opened in the second direction, and FIG. 30 is a perspective view of the lower hinge coupled to the door openable in the second direction.

As illustrated, in order to allow the lower door 22 to be opened in the second direction, the lower hinge 33 may be connected to the second lower mounting portion 2241b. The stopper 51 and the elastic hook 52 may be mounted to the second lower mounting portion 2241b of the lower cap 224. In this case, the lower hinge 33, the stopper 51, and the elastic hook 52 may be selectively disposed as a single set at one of left and right sides of the lower door 22.

The guide groove 400 located at the second lower mounting portion 2241b may be referred to as a second guide groove 400 in order to distinguish it from the guide groove 400 located at the first lower mounting portion 2241a.

Since the lower hinge 33 has a symmetrical structure and shape in left and right directions, selective contact and engagement with the stopper 51 and the elastic hook 52 may be achieved even when the lower hinge 33 is connected to the second lower mounting portion 2241b.

When the lower hinge 33 is mounted to the second lower mounting portion 2241b, a coupling position of the lower hinge pins 333 may be changed. That is, the second hinge pin 3332 may be coupled to the first pin hole 3321, and the first hinge pin 3331 may be coupled to the second pin hole 3322.

When the lower hinge 33 is relocated from the first lower mounting portion 2241a to the second lower mounting portion 2241b, the first hinge pin 3331 may be separated from the third pin hole 3323 and coupled to the second pin hole 3322. That is, without adding any additional components, the lower hinge 33 may be arranged to correspond to a change in the opening direction of the lower door 22 by changing the mounting position of the lower hinge pins 333.

When the lower hinge 33 is mounted to the second lower mounting portion 2241b, the leg 54 coupled to the leg coupling portion 113 disposed at a left side of a lower surface of the cabinet 10 may be detached and then coupled to the leg coupling portion 113 disposed at a right side of the lower surface of the cabinet 10.

A refrigerator according to an embodiment of the present invention has the following advantages.

According to an embodiment of the present invention, a single hinge may have a structure configured to be selectively mounted at left and right sides of the door. That is, a hinge having a single structure may be mounted at both the left and right sides of the door. Accordingly, since it is not necessary to separately design and manufacture different hinges depending on an opening and closing direction of the refrigerator door, manufacturing costs may be reduced.

Further, the hinge mounted at one side may be detached and moved to the other side for mounting, thereby allowing the opening and closing direction of the door to be changed without additionally providing a separate hinge. Accordingly, user convenience may be improved.

Further, since a hinge having a plurality of hinge pins may be turned upside down in a vertical direction and selectively mounted at both sides of the door, convenience in assembling the door may be improved.

Further, hinge pins of a hinge having a plurality of hinge pins may be separated and rearranged according to a mounting position of the hinge, thereby improving convenience in assembling the door.

Further, a mounting portion to which the hinge is mounted may have a symmetrical structure at both sides of the door, and a common stopper, an elastic hook, and a guide cover may be mounted to the mounting portion, thereby improving productivity and assembly workability.

What is claimed is:

1. A refrigerator comprising:
a cabinet forming an upper storage space and a lower storage space arranged vertically;
an upper door configured to open and close the upper storage space, a lower surface of the upper door having a first lower mounting portion and a second lower mounting portion formed at left and right sides of the lower surface;
a lower door configured to open and close the lower storage space, an upper surface of the lower door having a first upper mounting portion and a second upper mounting portion formed at left and right sides of the upper surface; and
a center hinge mounted to the cabinet,
wherein the center hinge comprises:
a hinge plate extending between the upper door and the lower door, and
a pair of hinge pins passing through the hinge plate and protruding upward and downward, the pair of hinge pins being spaced apart from each other, and
wherein, according to an opening direction of the doors, the center hinge is configured to selectively mounted to one of (i) the first lower mounting portion and the first upper mounting portion or (ii) the second lower mounting portion and the second upper mounting portion.

2. The refrigerator of claim 1,
wherein the center hinge is connected to the first lower mounting portion and the first upper mounting portion in a first state such that the upper door and the lower door are opened in a first direction, and
the center hinge is connected to the second lower mounting portion and the second upper mounting portion in a second state such that the upper door and the lower door are opened in a second direction,
wherein the second state is an inverted state of the first state in a vertical direction.

3. The refrigerator of claim 2,
wherein the hinge plate comprises:
a plate fixing portion fixed to a front surface of the cabinet; and
a plate extension portion extending from the plate fixing portion and having the pair of hinge pins mounted to the plate extension portion,
wherein the plate extension portion extends forward from a middle height of the plate fixing portion.

4. The refrigerator of claim 3,
wherein fastening holes through which fastening members are fastened are formed at one side of the hinge plate with respect to a center of the hinge plate,
and the plate extension portion is formed at another side of the hinge plate.

5. The refrigerator of claim 4,
wherein the hinge plate is formed of a metal material,
and the plate extension portion is formed by bending from one end of the plate fixing portion.

6. The refrigerator of claim 4,
wherein a plurality of fastening holes are formed in the plate fixing portion,
and the plate extension portion is formed on an extension line passing through the plurality of fastening holes.

7. The refrigerator of claim 4,
wherein the plate extension portion is positioned at a middle height of the plate fixing portion.

8. The refrigerator of claim 1,
wherein the first lower mounting portion and the second lower mounting portion are formed symmetrically with respect to a center of the upper door,
and the first upper mounting portion and the second upper mounting portion are formed symmetrically with respect to a center of the lower door.

9. The refrigerator of claim 1,
wherein each of the first lower mounting portion, the second lower mounting portion, the first upper mounting portion, and the second upper mounting portion has a guide groove into which the pair of hinge pins are inserted,
the guide groove guiding rotation of the doors during opening and closing.

10. The refrigerator of claim 9,
wherein a guide member formed of a wear-resistant material is mounted in each of the mounting portions,
and the guide groove is formed in the guide member.

11. The refrigerator of claim 9,
wherein the guide grooves formed in the first and second lower mounting portions are symmetrical with respect to a center of the upper door,
and the guide grooves formed in the first and second upper mounting portions are symmetrical with respect to a center of the lower door.

12. A refrigerator comprising:
a cabinet forming a storage space;
a door configured to open and close the storage space; and
a hinge mounted to the cabinet and rotatably connecting the door to the cabinet,
wherein the door has a first mounting portion for opening the door in a first direction and a second mounting portion for opening the door in a second direction,
wherein the hinge comprises:
a hinge plate mounted to the cabinet; and
a pair of hinge pins detachably mounted to the hinge plate,
wherein,
the pair of hinge pins are mounted to the hinge plate in a first arrangement and connected to the first mounting portion to open the door in the first direction, and
the pair of hinge pins are mounted to the hinge plate in a second arrangement and connected to the second mounting portion to open the door in the second direction.

13. The refrigerator of claim 12,
wherein the first arrangement and the second arrangement are symmetrical with respect to a center of the hinge plate.

14. The refrigerator of claim 13,
wherein three pin holes are formed in the hinge plate,
and the pair of hinge pins are mounted to two of the three pin holes.

15. The refrigerator of claim 12,
wherein a plurality of pin holes are formed in the hinge plate,
the plurality of pin holes comprising:
a first pin hole formed on an extension line passing through a center of the hinge plate; and
a second pin hole and a third pin hole positioned forward of the first pin hole and disposed at opposite sides of the extension line.

16. The refrigerator of claim 15,
wherein the second pin hole and the third pin hole are spaced apart from the extension line by equal distances and spaced forward from the first pin hole by equal distances.

17. The refrigerator of claim 15,
wherein the pair of hinge pins comprise:
a first hinge pin mounted to the first pin hole; and
a second hinge pin selectively mounted to one of the second pin hole and the third pin hole according to the opening direction of the door.

18. The refrigerator of claim 15,
wherein threads are formed on the hinge pins and in the pin holes such that the hinge pins are screw-coupled to the hinge plate.

19. The refrigerator of claim 12,
wherein the hinge plate is formed symmetrically in left and right directions with respect to a center of the hinge plate.

20. The refrigerator of claim 19,
wherein locking portions protrude from left and right sides of the hinge plate with respect to the center of the hinge plate, and
an elastic hook configured to be engaged with the locking portion is formed in the first mounting portion or the second mounting portion.
